(19) United States
(12) Patent Application Publication
(10) Pub. No.: US 2020/0326645 A1
(43) Pub. Date: Oct. 15, 2020

(54) TRANSFER BELT, TRANSFER UNIT, AND IMAGE FORMING APPARATUS

(71) Applicant: FUJI XEROX CO., LTD., Tokyo (JP)

(72) Inventors: Hiroaki TANAKA, Kanagawa (JP); Satoya SUGIURA, Kanagawa (JP); Shigeru FUKUDA, Kanagawa (JP); Masato FURUKAWA, Kanagawa (JP); Futoshi TAKEI, Kanagawa (JP)

(73) Assignee: FUJI XEROX CO., LTD., Tokyo (JP)

(21) Appl. No.: 16/722,471

(22) Filed: Dec. 20, 2019

(30) Foreign Application Priority Data
Apr. 10, 2019 (JP) 2019-074535

(51) Int. Cl. G03G 15/16; H01B 3/30; C08G 73/14; C08G 73/10

(52) U.S. Cl. CPC G03G 15/162; G03G 15/1685; C08G 73/1035; C08G 73/14; H01B 3/306

(57) ABSTRACT

A transfer belt includes a resin base material layer and a surface layer, wherein the surface layer contains a polyamide-imide resin A, a siloxane-modified imide resin B, and a conductive material.

### CROSS-REFERENCE TO RELATED APPLICATIONS

This application is based on and claims priority under 35 USC 119 from Japanese Patent Application No. 2019-074535 filed Apr. 10, 2019.

### BACKGROUND

### (i) Technical Field

The present invention relates to a transfer belt, a transfer unit, and an image forming apparatus.

### (ii) Related Art

In an image forming apparatus using an electrophotographic system (a copying machine, a facsimile, a printer, or the like), a toner image formed on a surface of an image holding member is transferred to a surface of a recording medium and is then fixed on the recording medium, thereby forming an image. A tubular belt is used as a belt member or the like in such a transfer unit that transfers the toner image to the recording medium. Also, a resin composition containing a resin such as an imide resin is used for forming such a belt.

For example, JP-A-2001-042658 discloses a conductive belt, which includes at least two layers, in which at least a surface layer of the layers is formed of a composition containing a high-molecular-weight polymer that has a siloxane bond, a water drop contact angle of the surface layer is 90 degrees or more, a coefficient of dynamic friction with urethane rubber is 0.1 or less, and a volume resistance value is 10 to 10⁶ Ω·cm.

JP-A-2007-072197 discloses an endless tubular belt including a siloxane-modified polyimide resin or a siloxane-modified polyamide-imide resin, in which a front surface side of the endless tubular belt has characteristics of polyimide and a rear surface side thereof has characteristics of silicone, and which is composed of an inclined material with successively changing physical properties in a thickness direction from the front surface side toward the rear surface side.

JP-A-2006-058561 discloses a seamless intermediate transfer belt with a single layer structure, which is formed using belt forming materials containing (A) to (D) below as essential components, in which a friction coefficient of the front surface of the seamless intermediate transfer belt is smaller than a friction coefficient of the rear surface:

(A) a polyethersulfone resin;

(B) a polyamide-imide resin;

(C) at least one compound selected from a group consisting of silicone, a silicone-modified compound, a fluorine compound, and a fluorine-modified compound; and

(D) a conductive filler.

### SUMMARY

Aspects of non-limiting embodiments of the present disclosure relate to provide a transfer belt being excellent in properties of transferring toner (toner transferring properties) to an uneven sheet as compared with a transfer belt composed of a polyimide resin single layer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transfer belt including: a resin base material layer; and a surface layer,

wherein the surface layer contains a polyamide-imide resin A, a siloxane-modified imide resin B, and a conductive material.

### BRIEF DESCRIPTION OF THE DRAWINGS

Exemplary embodiments of the present invention will be described in detail based on the following figures, wherein:

FIG. 1 is an outline configuration diagram illustrating an example of an image forming apparatus according to an embodiment.

### DETAILED DESCRIPTION

Hereinafter, an embodiment will be described. The description and examples are for describing an illustrative embodiment and are not intended to limit the scope of the embodiment.

In the embodiment, numerical ranges represented using “to” represent ranges including numerical values described before and after “to” as minimum values and maximum values. In the numerical ranges described in a stepwise manner in the embodiment, an upper limit value or a lower limit value described for representing one numerical range may be replaced with an upper limit value or a lower limit value of another numerical range described in a stepwise manner. In a numerical range described in the embodiment, an upper limit value or a lower limit value of the numerical range may be replaced with a value described in examples. In the embodiment, the term “process” includes not only an independent process but also a case that cannot be explicitly distinguished from another process as long as a prescribed purpose of the process is achieved. In a case in which the embodiment is described with reference to a drawing in the embodiment, a configuration of the embodiment is not limited to the configuration illustrated in the drawing. Also, the sizes of members in each drawing are conceptually illustrated, and relative size relationships between the members are not limited thereto. Each component in the embodiment may contain a plurality of corresponding substances. In a case in which the amount of each component in a composition is mentioned in the embodiment, and a plurality of kinds of substance corresponding to each component is present in the composition, the amount means a total amount of the plurality of kinds of substance that is present in the composition unless otherwise particularly indicated.

<Transfer Belt>

A transfer belt according to the embodiment has at least a resin base material layer and a surface layer, and the surface layer contains a polyamide-imide resin A, a siloxane-modified imide resin B, and a conductive material. Also, the transfer belt according to the embodiment is preferably used as an intermediate transfer belt.

In a belt in the related art, a method of applying a polymer having a siloxane bond on a surface layer as a thin film as disclosed in JP-A-2001-042658 is used. According to the aforementioned method, excellent releasability of the surface layer may be achieved, but since the surface layer does not contain a conductive material, it may not be possible to sufficiently prevent electrical discharge of a toner at the time of transferring, so that toner transferring properties with respect to an uneven sheet may be degraded in some cases. The transfer belt according to the embodiment has excellent toner transferring properties with respect to an uneven sheet with the aforementioned configuration. Although the reason thereof is not sure, the following reason is assumed. Since at least two layers, namely the resin base material layer and the surface layer are provided, the surface layer contains the polyamide-imide resin A, the siloxane-modified imide resin B, and the conductive material, electrical discharge of the toner due to a gap between the uneven sheet and the transfer belt is prevented at the time of transferring, and also an electrostatic adhesion force is reduced. Further, since the polyamide-imide resin A and the siloxane-modified imide resin B are used together, it is assumed that a non-electrostatic adhesion force is also reduced, dispersibility of the conductive material in the surface layer is improved so that the electrical discharge at an exposure portion of the conductive material is dispersed and prevented, or both thereof occur. As a result, toner transferring properties with respect to an uneven sheet (hereinafter, also simply referred to as “uneven sheet transferring properties”) are improved.

The transfer belt according to the embodiment may be either an ended belt or an endless belt or may be a belt with a structure that further has a layer other than the resin base material layer and the surface layer. Also, it is needless to state that the transfer belt according to the embodiment may be applied to printing on a recording medium other than an uneven sheet. Examples of the uneven sheet include an embossed sheet and a debossed sheet.

(Surface Layer)

The transfer belt according to the embodiment has the surface layer containing the polyamide-imide resin A, the siloxane-modified imide resin B, and the conductive material. The surface layer may be provided on one surface side or both surface sides of the resin base material layer. In particular, the transfer belt according to the embodiment preferably has the surface layer at least on an outer circumferential surface side of the resin base material layer. Also, the surface layer is preferably an outermost layer of the transfer belt according to the embodiment.

—Surface Resistance of Surface Layer—

The surface resistance of the surface layer when a voltage of 100 V is applied to the surface layer for three seconds is preferably 10.0 (log Ω/sq.) or more and 15.0 (log Ω/sq.) or less, is more preferably 10.5 (log Ω/sq.) or more and 14.0 (log Ω/sq.) or less, and is particularly preferably 11.0 (log Ω/sq.) or more and 13.5 (log Ω/sq.) or less in terms of uneven sheet transferring properties. Also, the unit log Ω/sq. of the surface resistance is for representing a surface resistance using a logarithmic value of a resistance value per unit area and is also expressed as log (Ω/sq.), log Ω/square, log Ω/□, or the like. The surface resistance when the voltage of 10 V is applied to the surface layer for three seconds is measured by the following method. A microammeter (R8430A manufactured by Advantest) is used as a resistance measuring machine, a UR probe (manufactured by Mitsubishi Chemical Analytech) is used as a probe, with respect to eighteen points in total of the surface layer of the transfer belt, namely six points in a circumferential direction×three points at the center and both ends in a width direction, surface resistances (log Ω/sq.) of the surface layer of the transfer belt are measured at a voltage of 100 V for an application time of three seconds under pressure application of 1 kgf, and an average value thereof is calculated. Also, the measurement is performed in an environment at a temperature of 22° C. and a humidity of 55% RH.

—Polyamide-Imide Resin A—

The surface layer contains the polyamide-imide resin A (also simply referred to as a “resin A”). Examples of the polyamide-imide resin include a polymer of trivalent carboxylic acid (tricarboxylic acid) having an acid anhydride group with an isocyanate or a diamine. Preferable examples of tricarboxylic acid include trimellitic anhydride and derivatives thereof. Tetracarboxylic dianhydride, aliphatic dicarboxylic acid, an aromatic dicarboxylic acid, or the like may be used in combination with tricarboxylic acid.

Examples of the isocyanate include 3,3′-dimethylbiphenyl-4,4′-diisocyanate, 2,2′-dimethylbiphenyl-4,4′-diisocyanate, biphenyl-4,4′-diisocyanate, biphenyl-3,3′-diisocyanate, biphenyl-3,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, and naphthalene-2,6-diisocyanate. Examples of diamine include a compound that has a structure similar to that of the isocyanate and has an amino group instead of an isocyanato group.

Examples of the diamine include aliphatic diamine, alicyclic diamine, aromatic diamine, and aromatic diamine including a heterocycle.

Diamine is not particularly limited as long as diamine is a diamine compound having two amino groups in a molecular structure. Examples of the diamine include aromatic diamine such as p-phenylenediamine, m-phenylenediamine, 4,4′-diaminodiphenylmethane, 4,4′-diaminodiphenylethane, 4,4′-diaminodiphenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1, 3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenylether, 2,7-diaminofluorene, 2,2-bis(4-aminophenyl)hexafuoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(rifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyeneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamine having two amino groups bonded to an aromatic ring and a hetero atom other than a nitrogen atom of the amino group such as diaminotetraphenylthiophene; and aliphatic and alicyclic diamine such as 1,1-methxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanilendimethylenediamine, tricyclo[6,2,1,0^{2,7}]-undecylendimethyldiamine, and 4,4′-methylenebis(cyclohexylamine). One kind of diamine described above may be used alone, or two or more kinds selected therefrom may be used in combination.

The surface layer may contain one kind of polyamide-imide resin A alone or two or more kinds of polyamide-imide resin A. The content of polyamide-imide resin A is preferably 20% by weight or more and 95% or less, is more preferably 40% by weight or more and 90% by weight or less, is further preferably 50% by weight or more and 85% by weight or less, and is particularly preferably 60% by weight or more and 80% by weight or less.

—Siloxane-Modified Imide Resin B—

The surface layer contains a siloxane-modified imide resin B (also simply referred to as a “resin B”). The siloxane-modified imide resin B is an imide resin that is obtained by modifying an imide resin with a silicone resin and that has a siloxane bond. Preferable examples of the imide resin as a target of modification includes the following unmodified imide resin.

<<Unmodified Imide Resin>>

The unmodified imide resin represents an imide resin that has not been modified, and the imide resin represents a resin containing a configuration unit having an imide bond. The type of imide resin is not particularly limited, examples of the imide resin include a polyimide resin, a polyamide-imide resin, and a polyetherimide resin, and one kind thereof may be used alone, or two or more kinds thereof may be used in combination. Examples of the polyamide-imide resin include the polyimide resin. The unmodified imide resin preferably contains at least either a polyimide resin or a polyetherimide resin or is preferably a polyetherimide resin in terms of uneven sheet transferring properties.

[Polyimide Resin]

Examples of the polyimide resin include an imidized product of polyamic acid (a precursor of the polyimide resin) that is a polymer of a tetracarboxylic dianhydride and a diamine compound. Specific examples of the polyimide resin include a product obtained by performing a polymerization reaction of equimolar amounts of tetracarboxylic dianhydride and diamine compound in a solvent to obtain a solution of polyamic acid and imidizing the polyamic acid.

Examples of the polyimide resin include a resin having a configuration unit represented by Formula (1) below.

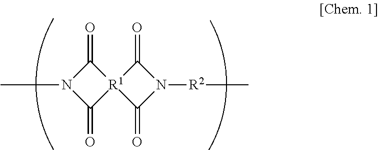

(In Formula (1), R¹ represents a quaternary organic group and is an aromatic group, an aliphatic group, a cyclic aliphatic group, a group as a combination of an aromatic group and an aliphatic group, or a substituted group thereof (for example, a residue of tetracarboxylic dianhydride, which will be described later, is exemplified). R² represents a bivalent organic group and is an aromatic group, an aliphatic group, a cyclic aliphatic group, a group as a combination of an aromatic group and an aliphatic group, or a substituted group thereof (for example, a residue of a diamine compound, which will be described later, is exemplified).)

Specific examples of the tetracarboxylic dianhydride include pyromellitic dianhydride, 3,3′,4,4′-benzophenonetetracarboxylic dianhydride, 3,3′,4,4′-biphenytetracarboxylic dianhydride, 2,3,3′,4-biphenyltetracarboxilic dianhydride, 2,3,6,7-naphthalenetetracarboxylic dianhydride, 1,2,5,6-naphthalenetetracarboxylic dianhydride, 1,4,5,8-naphthalenetetracarboxylic dianhydride, 2,2′-bis(3,4-dicarboxyphenyl)sulfonic dianhydride, perylene-3,4,9,10-tetracarboxylic dianhydride, bis(3,4-dicarboxyphenyl)ether dianhydride, and ethylenetetracarboxylic dianhydride.

Meanwhile, specific examples of the diamine compound include 4,4′-diaminodiphenylether, 4,4′-diaminodiphenylmethane, 3,3′-diaminodiphenylmethane, 3,3′-dichlorobenzidine, 4,4′-diaminodiphenylsulfide, 3,3′-diaminodiphenylsulfone, 1,5-diaminonaphthalene, m-phenylenediamine, p-phenylenediamine, 3,3′-dimethyl4,4′-biphenyldiamine, benzidine, 3,3′-dimethylbenzidine, 3,3′-dimethoxybenzidine, 4,4′-diaminodiphenylsulfone, 4,4′-diaminodiphenylpropane, 2,4-bis(μ-amino-tert-butyl)toluene, bis(p-β-amino-tert-butylpheny)ether, bis(p-β-methyl-δ-aminophenyl)benzene, bis-p-(1,1-dimethyl-5-amino-pentyl)benzene, 1-isopropyl-2,4-m-phenylenediamine, m-xylylenediamine, p-xylylenediamine, di(p-aminocyclohexyl)methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminoproboxyetane, 22-dimethylpropylenediamine, 3-methoxyhexamethylenediamine, 2,5-dimethylheptamethylenediamine, 3-metbylheptamethylenediamine, 5-methyinonamethylenediamine, 2,17-diaminoeicosadecane, 1,4-diaminocyclohexane, 1,10-diamino-1,10-dimethyldecane, 12-diaminooctadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, and H₂N(CH₂)₃N(CH₃)₂(CH₂)₃NH₂.

[Polyetherimide Resin]

Examples of the polyetherimide resin includes a product obtained through a polymerization reaction between a dicarboxylic dianhydride containing an ether bond and diamine. That is, examples of the polyetherimide resin includes a polyetherimide resin that has at least a repeated unit structure derived from a dicarboxylic dianhydride containing an ether bond and a diamine. As the diamine, the examples described above in regard to the polyamide-imide resin A are preferably used.

Examples of dicarboxylic dianhydride containing an ether bond include 2,2-bis[4-(3,4-dicarboxyphenoxy)phenyl]propane dianhydride, 4,4′-bis(3,4-dicarboxyphenoxy)diphenylether dianhydride, 4,4′-bis(3,4-dicarboxyphenoxy)diphenylsulfide dianhydride, 4,4′-bis(3,4-dicarboxyphenoxy)benzophenone dianhydride, 4,4′-bis(3,4-dicarboxyphenoxy)diphenylsulfone dianhydride, 2,2-bis[4-(2,3-dicarboxyphenoxy)phenyl]propane dianhydride, 4,4′-bis(2,3-dicarboxyphenoxy)diphenylether dianhydride, 4,4′-bis(2,3-dicarboxyphenoxy)diphenylsulfide dianhydride, 4,4′-bis(2,3-dicarboxyphenoxy)benzophenone dianhydride, 4,4′-bis(2,3-dicarboxyphenoxy)diphenylsulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenylether dianhydride, 4-(2,3-dicarboxyphenoxy)-4′-(3,4-dicarboxyphenoxy)diphenylsulfide dianhydride, 4-(2,3-dicarboxyphenoxy)-4′-(3,4-dicarboxyphenoxy)benzophenone dianhydride, and 4-(2,3-dicarboxyphenoxy)-4′-(3,4-dicarboxyphenoxy)diphenylsulfone dianhydride. One kind of dicarboxylic dianhydride described above may be used alone, or two or more kinds selected therefrom may be used in combination.

[Silicone Modification]

The silicone resin used for silicone modification may be selected from known silicone resins, examples thereof include a methyl-based straight silicone resin, a methylphenyl-based straight silicone resin, an acrylic resin-modified silicone resin, an ester resin-modified silicone resin, an epoxy resin-modified silicone resin, an alkyd resin-modified silicone resin, and a rubber-based silicone resin, and a dimethylsiloxane resin is particularly preferably used in terms of easiness in treatment for the imide resin.

The amount of modification of the siloxane-modified imide resin B is preferably 40% by weight or more and 90% by weight or less and is more preferably 50% by weight or more and 80% by weight or less with respect to the total weight of the siloxane-modified imide resin B in terms of uneven sheet transferring properties. Also, the amount of modification of the siloxane-modified imide resin is the amount of siloxane group with respect to the entire molecular weight of the siloxane-modified imide resin.

Specific preferable examples of the siloxane-modified imide resin B include a siloxane-modified polyetherimide resin obtained by modifying a polyetherimide resin with a silicon resin, and examples thereof include a reaction product of aromatic dicarboxylic dianhydride, amine terminal organosiloxane, and diamine.

Examples of commercially available siloxane-modified polyetherimide resin (a copolymer of a polyetherimide resin and a silicone resin) include SILTEM STM1500, 1600, and 1700 manufactured by SABC Innovative Plastics.

The surface layer may contain one kind of siloxane-modified imide resin B or may contain two or more kinds of siloxane-modified imide resin B. The content of the siloxane-modified imide resin B is preferably 0.5% by weight or more and 50% by weight or less, is more preferably 1% by weight or more and 30% by weight or less, is further preferably 2% by weight or more and 20% or less, and is particularly preferably 3% by weight or more and 15% by weight or less with respect to the total weight of the surface layer in terms of uneven sheet transferring properties.

[Content Ratio Between Resin A and Resin B]

A ratio (WB/WA) between the content WA of the resin A and the content WB of the resin B in the surface layer is preferably 0.01 or more and 0.50 or less, is more preferably 0.03 or more and 0.30 or less, is further preferably 0.04 or more and 0.25 or less, and is particularly preferably 0.05 or more and 0.20 or less in terms of uneven sheet transferring properties.

[Weight Average Molecular Weights of Resin A and Resin B]

Since the resin A and the resin B may be mixed in an approximately uniform state even if the weight average molecular weights thereof are independently 50 thousands or more, it is possible to obtain a belt with excellent fracture durability. Also, the weight average molecular weight of the resin B is preferably smaller than the weight average molecular weight of the resin A in terms of mixing properties. Also, a difference between the weight average molecular weights (Mw) of the resin A and the resin B is preferably within 100,000 an is more preferably within 50,000 in terms of obtaining a belt with enhanced mixing properties between resins and excellent fracture durability.

The weight average molecular weights of the resins in the embodiment are measured by a gel permeation chromatography (GPC) method under the following measurement conditions.
Column: Tosoh TSKgelα-M (7.8 mm I.D×30 cm)
Eluent: DMF (dimethylformamide)/30 mmLiBr/60 mm phosphoric acid
Flow rate: 0.6 mL/min
Injection amount: 60 μL
Detector: RI (Diffraction refractive index detector)

Conductive Material

The surface layer contains a conductive material. Examples of the conductive material include carbon black; metal such as aluminum and nickel; metal oxide such as yttrium oxide and tin oxide, ion conductive substances such as potassium titanate and potassium chloride; and conductive polymer such as polyaniline, polypyrrole, polysulsulfone, and polyacetylene. Among them, carbon black is preferably used in terms of dispersibility, conductivity, and economy. Carbon black has excellent conductivity and may impart high conductivity with a small content.

Examples of carbon black include Ketjen black, oil furnace black, channel black, acetylene black, and carbon black with an oxidized surface (hereinafter, referred to as “surface treated carbon black). Among them, surface treated carbon black is preferably used in terms of electrical resistance stability over time. Surface treated carbon black is obtained by applying, for example, a carboxyl group, a quinone group, a lactone group, a hydroxy group, or the like to the surface thereof. Examples of a method of the surface treatment include an air oxidation method in which a reaction is caused through a contact with air in a high-temperature atmosphere, a method in which a reaction is caused with nitrogen oxide or ozone at an ordinary temperature (for example, 22° C.), and a method in which oxidation is caused with ozone at a low temperature after air oxidation in a high-temperature atmosphere.

An average primary particle diameter of the conductive material is preferably 5 nm or more and 50 nm or less, is more preferably 10 nm or more and 30 nm or less, and is particularly preferably 15 nm or more and 25 nm or less. If an upper limit of the average primary particle diameter of the conductive material is 50 nm or less, sufficient dispersibility of the conductive material in the surface layer is obtained, and surface smoothness of the belt is thus improved, which is preferable. Meanwhile, the lower limit value of the average primary particle diameter of the conductive material is preferably 5 nm or more and is more preferably 10 nm or more in terms of preventing of aggregation at the time of dispersion.

The average primary particle diameter of the conductive material contained in the transfer belt according to the embodiment is measured by the following method. First, a measurement sample with a thickness of 100 nm is collected from the obtained belt using a microtome, and the measurement sample is observed using a transmission electron microscope (TEM). Then, diameters of circles that are equal to projection areas of 50 conductive material particles (conductive particles) are taken as particle diameters, and an average value thereof is employed as an average primary particle diameter.

The surface layer may contain one kind of conductive material or may contain two or more kinds of conductive materials. The content of conductive material is preferably 5% by weight or more and 50% by weight or less, is more preferably 10% by weight or more and 45% by weight or less, and is particularly preferably 15% by weight or more and 35% by weight or less with respect to the total weight of the surface layer in terms of uneven sheet transferring properties.

—Other Components—

The surface layer may contain other components than the aforementioned components. Examples thereof include an antioxidant for preventing thermal degradation of the belt, a surfactant for improving fluidity, and a heat-resistant aging inhibitor, and in particular, known additives to be blended in a belt for an image forming apparatus are exemplified. Also, silicon-containing particles such as silicone powder and silicone oil-containing silica may be blended in order to enhance strength. The content of other components is preferably 50% by weight or less, is more preferably 25% by weight or less, and is particularly preferably 10% by weight or less with respect to the total weight of the surface layer.

—Average Thickness of Surface Layer—

Although the average thickness of the surface layer may be appropriately adjusted, the average thickness is preferably 0.5 μm or more and 20 μm or less and is more preferably 1 μm or more and 10 μm or less in terms of durability and uneven sheet transferring properties. Also, the average thickness of each layer in the embodiment is measured and calculated by the following method. A section of a surface that is vertical to the surface direction of the transfer belt surface is observed using an optical microscope or a scanning electron microscope, and the thickness of each layer is measured. Fields of view at eighteen points in total, namely three points in the circumferential direction×six points in the axial direction of the belt, are extracted, values measured at ten or more locations for each field of view are averaged, and the eighteen values each averaged are averaged and designated as an average thickness.

(Resin Base Material Layer)

The transfer belt according to the embodiment has a resin base material layer. The resin base material layer is a layer that includes at least a resin. The resin contained in the resin base material layer is not particularly limited, and examples thereof include known resins, and the resin base material layer preferably contains an imide resin in terms of uneven sheet transferring properties, more preferably contains at least one kind of resin selected from a group consisting of a polyimide resin, a polyamide-imide resin, and a polyetherimide resin, and particularly preferably contains a polyimide resin.

The resin base material layer may contain one kind of resin alone or may contain two or more kinds of resin. Also, the content of the resin in the resin base material layer, preferably the content of imide resin is preferably 40% by weight or more and 95% by weight or less and is more preferably 60% by weight or more and 90% by weight or less with respect to the total weight of the resin base material layer in terms of uneven sheet transferring properties. Further, the content of polyimide resin in the resin base material layer is preferably 50% by weight or more and 100% by weight or less, is more preferably 70% by weight or more and 100% by weight or less, and is particularly preferably 90% by weight or more and 100% by weight or less with respect to the total weight of the resin contained in the resin base material layer in terms of uneven sheet transferring properties.

In addition, the resin base material layer preferably contains a conductive material in terms of uneven sheet transferring properties. Examples of the conductive material used for the resin base material layer includes the conductive materials described above in regard to the surface layer, and preferable aspects thereof are also similar to those described above. The resin base material layer may contain one kind of conductive material alone or may contain two or more kinds of conductive material. The content of conductive material is preferably 1% by weight or more and 50% by weight or less, is more preferably 5% by weight or more an 40% by weight or less, and is particularly preferably 10% by weight or more and 30% by weight or less with respect to the total weight of the resin base material layer in terms of uneven sheet transferring properties. Also, the content of the conductive material in the resin base material layer is preferably greater than the content of the conductive material in the surface layer in terms of uneven sheet transferring properties, is preferably 1.05 times or more and 2.0 times or less the content of the conductive material in the surface layer, and is particularly preferably 1.1 times or more and 1.5 times or less the content of the conductive material in the surface layer. Also, the conductive material in the resin base material layer and the conductive material in the surface layer are preferably the same conductive material in terms of uneven sheet transferring properties.

The resin base material layer may contain other components than the aforementioned components. Examples thereof include an antioxidant for preventing thermal degradation of the belt, a surfactant for improving fluidity, and a heat-resistant aging inhibitor, and in particular, known additives to be blended in a belt for an image forming apparatus are exemplified. Also, silicon-containing particles such as silicone powder and silicone oil-containing silica may be blended in order to enhance strength. The content of other components is preferably 50% by weight or less, is more preferably 25% by weight or less, and is particularly preferably 10% by weight or less with respect to the total weight of the resin base material layer.

—Average Thickness of Resin Base Material Layer—

Although the average thickness of the resin base material layer may be appropriately adjusted, the average thickness is preferably 30 μm or more and 300 μm or less, is more preferably 50 μm or more and 150 μm or less, and is particularly preferably 60 μm or more and 100 μm or less in terms of durability and uneven sheet transferring properties.

—Ratio Between Average Thickness of Resin Base Material Layer and Average Thickness of Surface Layer—

A ratio (TR/TS) of the average thickness TR of the resin base material layer and the average thickness TS of the surface layer is preferably 1 or more and 40 or less, is more preferably 1 or more and 30 or less, is further preferably 8 or more and 25 or less, and is particularly preferably 10 or more and 20 or less in terms of uneven sheet transferring properties.

The transfer belt according to the embodiment may be a transfer belt in which another layer is laminated on at least either between the surface layer and the resin base material layer or on the inner circumferential surface side.

(Volume Resistance of Transfer Belt)

In the transfer belt according to the embodiment, the volume resistance when a voltage of 100 V is applied to the transfer belt for five seconds is preferably 9.0 (log Ω·cm) or more and 13.5 (log Ω·cm) or less, is more preferably 9.5 (log Ω·cm) or more and 13.2 (log Ω·cm) or less, and is particularly preferably 10.0 (log Ω·cm) or more and 12.5 (log Ω·cm) or less in terms of uneven sheet transferring properties. The volume resistance when the voltage of 100 V is applied to the transfer belt for five seconds is measured by the following method. A microammeter (R8430A manufactured by Advantest) is used as a resistance measuring machine, a UR probe (manufactured by Mitsubishi Chemical Analytech) is used as a probe, with respect to eighteen points in total of the transfer belt, namely six points in a circumferential direction×three points at the center and both ends in a width direction, volume resistances (log Ω·cm) of the transfer belt are measured at a voltage of 10 V for an application time of five seconds under pressure application of 1 kgf, and an average value thereof is calculated. Also, the measurement is performed in an environment at a temperature of 22° C. and a humidity of 55% RH.

As specific purposes of the transfer belt according to the embodiment, the transfer belt is applied to belt members for a transfer unit, for example, an intermediate transfer belt, a primary transfer belt, a secondary transfer belt, and the like. In particular, the transfer belt according to the embodiment is preferably used as an intermediate transfer belt.

The belt according to the embodiment may also be used as a cylindrical solar battery base material and the like in addition to an endless belt for an image forming apparatus. In addition, the belt according to the embodiment may also be used for belt-shaped members such as a transport belt, a drive belt, a laminate belt, an electric insulating member, a pipe covering material, an electromagnetic wave insulating material, a heat source insulating member, and an electromagnetic wave absorption film, for example.

(Method of Producing Transfer Belt)

Although a method of producing the transfer belt according to the embodiment is not particularly limited, it is possible to produce the transfer belt by producing a mixture resin pellet containing the imide resin and the conductive material, forming the resin base material layer through melting extrusion, and applying to the surface layer forming dispersion containing the resin A, the resin B, and the conductive material to the resin base material layer, and drying the dispersion, for example. In the mixture resin pellet, respective components may be blended in accordance with a surface resistance, surface roughness, repeated bending durability, dimensional stability or the like to be obtained. Also, although a solvent for the surface layer-forming dispersion is not particularly limited, and a known solvent is used, a polar solvent, which will be described later, is preferably used.

Also, resin pellets that separately contain the conductive material and the respective resin components may be respectively produced, the resin pellets may be blended in accordance with a target surface resistance, surface roughness, repeated bending durability, dimensional stability, and the like, and melting extrusion may then be performed.

As another producing method, it is possible to produce the transfer belt by producing a resin base material layer-forming dispersion containing the imide resin and the conductive material in the polar solvent, applying the resin base material layer-forming dispersion to form a coating film and thereby to form a resin base material layer, applying a surface layer-forming dispersion containing the resin A, the resin B, and the conductive material to the resin base layer, and drying the surface layer-forming dispersion, for example.

Examples of the polar solvent include N-methyl-2-pyrrolidone (NMP), N,N-dimethylformamide (DMF), N,N-dimethylacetoamide (DMAc), N,N-diethylacetoamide (DEAc), dimethylsulfoxide (DMSO), hexamethylenephosphoramide (HMPA), N-methylcaprolactam, N-acetyl-2-pyrrolidone, and 1,3-dimethyl-2-imidazolidinone (N,N-dimethylimidazolidinone; DMI), one kind thereof may be used alone, or two or more kinds thereof may be used in combination.

<Transfer Unit, Process Cartridge, and Image Forming Apparatus>

A transfer unit according to the embodiment is a transfer unit provided with the transfer belt according to the embodiment. A process cartridge according to the embodiment is a process cartridge that is provided with the transfer unit according to the embodiment and is detachable from an image forming apparatus. An image forming apparatus according to the embodiment is an image forming apparatus including an image holing member, a charger unit that charges the surface of the image holding member, an electrostatic latent image forming unit that forms an electrostatic latent image on the charged surface of the image holding member, an developing unit that develops the electrostatic latent image formed on the surface of the image holding member with a developer containing a toner to form a toner image, and the transfer unit according to the embodiment that transfers the toner image to the surface of a recording medium.

Hereinafter, the image forming apparatus according to the embodiment will be described with reference to drawings.

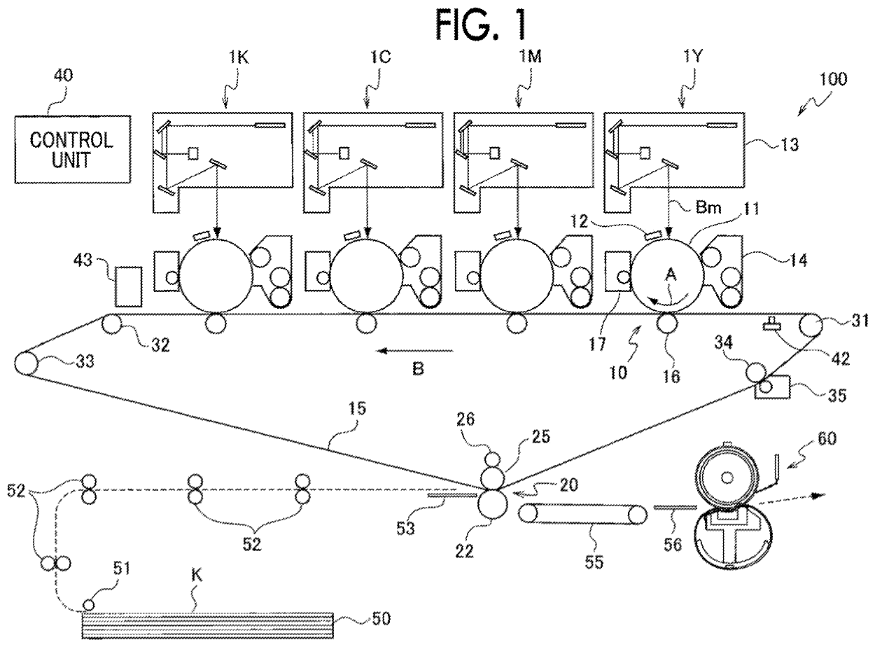

FIG. 1 is an outline configuration diagram illustrating a configuration of the image forming apparatus according to the embodiment. Also, the transfer belt according to the embodiment is applied as an intermediate transfer belt. In the image forming apparatus according to the embodiment, a portion including at least a transfer unit, for example, may have a cartridge structure (process cartridge) that is detachable from the image forming apparatus.

An image forming apparatus 100 according to the embodiment is an image forming apparatus based on an intermediate transfer method, which is typically called a tandem type, for example, as illustrated in FIG. 1 and includes plural image forming units 1Y, 1M, 1C, and 1K that form toner images of the respective color components by an electrophotographic system, a primary transfer unit 10 that sequentially transfer (primarily transfer) the respective color component toner images formed by the respective image forming units 1Y, 1M, 1C, and 1K onto an intermediate transfer belt 15, a secondary transfer unit 20 that collectively transfers (secondarily transfers) the superimposed toner image, which has been transferred onto the intermediate transfer belt 15, onto a sheet K that is a recording medium, and a fixing unit 60 that fixes the secondarily transferred image on the sheet K. Also, the image forming apparatus 100 has a control unit 40 that controls operations of the respective units (respective units).

Each of the image forming units 1Y, 1M, 1C, and 1K in the image forming apparatus 100 includes a photoreceptor 11 that rotates in the direction of the arrow A as an example of an image holding member that holds the toner image formed on the surface.

A charger 12 that charges the photoreceptor 11 as an example of the charging unit is provided, and a laser exposing unit 13 (in the drawing, an exposure beam is represented with a reference numeral Bm) that writes an electrostatic latent image on the photoreceptor 11 as an example of the latent image forming unit is provided, in the circumference of the photoreceptor 11.

Also, a developer 14, in which the respective color component toners are contained, which visualizes the electrostatic latent image on the photoreceptor 11 using a toner, as an example of the developing unit is provided, and a primary transfer roll 16 that transfers the respective color component toner images formed on the photoreceptor 11 onto the intermediate transfer belt 15 using the primary transfer unit 10 is provided, in the circumference of the photoreceptor 11.

Further, a photoreceptor cleaner 17 that removes a remaining toner on the photoreceptor 11 is provided, and electrophotography devices, namely the charger 12, the laser exposing unit 13, the developing unit 14, the primary transfer roll 16, the photoreceptor cleaner 17 are successively disposed in the rotation direction of the photoreceptor 11, in the circumference of the photoreceptor 11. These image forming units 1Y, 1M, 1C, and 1K are substantially linearly disposed in an order of yellow (Y), magenta (M), cyan (C), and black (K) from the upstream side of the intermediate transfer belt 15.

The intermediate transfer belt 15 that is an intermediate transfer member is formed to have volume resistance of 1×10⁶ Ωcm or more and 1×10¹⁴ Ωcm or less, and the thickness thereof is formed to about 0.1 mm, for example.

The intermediate transfer belt 15 is driven (rotated) in a circulated manner with various rolls at a speed in accordance with a purpose thereof in the B direction illustrated in FIG. 1. As the various rolls, a drive roll 31 that is driven by a motor (not illustrated) with excellent constant speed properties and causes the intermediate transfer belt 15 to rotate, a support roll 32 that supports the intermediate transfer belt 15 extending substantially linearly in an alignment direction of the respective photoreceptors 11, a tensile force application roll 33 that serves as a correction roll that applies a tensile force to the intermediate transfer belt 15 and prevents the intermediate transfer belt 15 from meandering, a rear surface roll 25 that is provided at the secondary transfer unit 20, and a cleaning rear surface roll 34 that is provided at the cleaning unit to wipe the toner remaining on the intermediate transfer belt 15 are included.

The primary transfer unit 10 is configured to include the primary transfer roll 16 that is disposed so as to face the photoreceptor 11 with the intermediate transfer belt 15 interposed therebetween. Also, the primary transfer roll 16 is disposed such that the primary transfer roll 16 is in pressure contact with the photoreceptor 11 with the intermediate transfer belt 15 interposed therebetween, and further, a voltage with a polarity that is opposite to the toner charging polarity (this is assumed to be a negative polarity; the same applies to the following description) is applied to the primary transfer roll 16. In this manner, the toner images of the respective photoreceptors 11 are sequentially and electrostatically suctioned by the intermediate transfer belt 15, and a superimposed toner image is thus formed on the intermediate transfer belt 15.

The secondary transfer unit 20 is configured to include the rear surface roll 25 and the secondary transfer roll 22 that is disposed on a toner image holding surface side of the intermediate transfer belt 15.

The rear surface roll 25 is formed to have a surface resistance of 1×10⁷ Ω/sq. or more and 1×10¹⁰ Ω/sq. or less, and hardness is set to 70° (ASKER C manufactured by Kobunshi Keiki Co., Ltd. the same applies to the following description), for example. The rear surface roll 25 is disposed on the rear surface side of the intermediate transfer belt 15 and forms a facing electrode of the secondary transfer roll 22, and a power supply roll 26 made of metal to which a secondary transfer bias is stably applied is disposed in a contact manner.

Meanwhile, the secondary transfer roll 22 is a cylindrical roll with a volume resistance of 10^{7.5} Ωcm or more and 10^{8.5} Ωcm or less. In addition, the secondary transfer roll 22 is disposed such that the second transfer roll 22 is in pressure contact with the rear surface roll 25 with the intermediate transfer belt 15 interposed therebetween, further, the second transfer roll 22 is grounded, a secondary transfer bias is formed with the rear surface roll 25, and a toner image is secondarily transferred to the sheet K transported to the secondary transfer unit 20.

Also, an intermediate transfer belt cleaner that removes the remaining toner and paper powder on the intermediate transfer belt 15 after the secondary transfer and cleans the surface of the intermediate transfer belt 15 is provided on the downstream side of the secondary transfer unit 20 of the intermediate transfer belt 15 such that the intermediate transfer belt cleaner 35 may freely be brought into contact therewith and be separate therefrom.

Also, the intermediate transfer belt 15, the primary transfer unit 10 (primary transfer roll 16), and the secondary transfer unit 20 (secondary transfer roll 22) correspond to one example of the transfer unit.

Meanwhile, a reference sensor (home position sensor) 42 that serves as a reference for choosing image forming timing of the respective image forming units 1Y, 1M, 1C, and 1K is disposed on the upstream side of the yellow image forming unit 1Y. Also, an image density sensor 43 for adjusting image quality is disposed on the downstream side of the black image forming unit 1K. The reference sensor 42 recognizes a mark provide on the backside of the intermediate transfer belt 15 and generates a reference signal, and the respective image forming units 1Y, 1M, 1C, and 1K are configured to start image formation in response to an instruction from the control unit 40 on the basis of recognition of the reference signal.

Further, the image forming apparatus according to the embodiment includes a sheet containing unit 50 that serves as a transport unit for transporting the sheet K and contains the sheet K, a sheet supply roll 51 that takes and transports the sheet K stacked in the sheet containing unit 50 at a predefined timing, a transport roll 52 that transports the sheet K fed by the sheet supply roll 51, a transport guide 53 that sends the sheet K transported by the transport roll 52 to the secondary transfer unit 20, a transport belt 55 that transports the sheet K that is transported after secondary transfer is performed thereon by the secondary transfer roll 22 to the fixing unit 60, and a fixing inlet guide 56 that guides the sheet K to the fixing unit 60.

Next, a basic image creation process of the image forming apparatus according to the embodiment will be described.

In the image forming apparatus according to the embodiment, image data output from an image reader, which is not illustrated in the drawing, a personal computer (PC), which is not illustrated in the drawing, or the like is subjected to image processing by an image processing system, which is not illustrated in the drawing, and image creating operations are executed thereon by the image forming units 1Y, 1M, 1C, and 1K.

In the image processing system, image processing including various kinds of image editing and the like such as shading correction, positional deviation correction, brightness/color space conversion, gamma correction, frame deletion and color editing, and motion editing is performed on reflectance data input. The image data after being subjected to the image processing is converted into color material gradation data of four colors Y, M, C, and K and is then output to the laser exposing unit 13.

In the laser exposing unit 13, the respective photoreceptors 11 of the image forming units 1Y, 1M, 1C, and 1K are irradiated with the exposure beam Bm emitted from a semiconductor laser, for example, in accordance with the color material gradation data input. The surfaces of the respective photoreceptors 11 of the image forming units 1Y, 1M, 1C, and 1K are charged by the charger 12 and are subjected to scanning exposure by the laser exposing unit 13, thereby forming electrostatic latent images. The formed electrostatic latent images are developed as toner images of the respective colors Y, M, C, and K by the respective image forming units 1Y, 1M, 1C, and 1K.

The toner images formed on the photoreceptors 11 of the image forming units 1Y, 1M, 1C, and 1K are transferred onto the intermediate transfer belt 15 by the primary transfer unit 10 at which the respective photoreceptors 11 and the intermediate transfer belt 15 are brought into contact with each other. More specifically, a voltage (primary transfer bias) with a polarity that is opposite to the charging polarity (negative polarity) of the toners is applied to the base material of the intermediate transfer belt 15 by the primary transfer roll 16, and the toner images are primarily transferred to the surface of the intermediate transfer belt 15 in a sequentially superimposed manner, at the primary transfer unit 10.

After the toner images are primarily transferred in a sequential manner on the surface of the intermediate transfer belt 15, the intermediate transfer belt 15 moves, and the toner images are transported to the secondary transfer unit 20. If the toner images are transported to the secondary transfer unit 20, the sheet supply roll 51 rotates at a timing at which the toner images are transported to the secondary transfer unit 20, and the sheet K with a target size is supplied from the sheet containing unit 50, at the transport unit. The sheet K supplied by the sheet supply roll 51 is transported by the transport roll 52 and reaches the secondary transfer unit 20 via the transport guide 53. Before the sheet K reaches the secondary transfer unit 20, the sheet K is once stopped, and positioning between the position of the sheet K and the position of the toner images is performed by a positioning roll (not illustrated) rotating at a moving timing of the intermediate transfer belt 15 on which the toner images are held.

At the secondary transfer unit 20, the secondary transfer roll 22 is pressurized against the rear surface roll 25 via the intermediate transfer belt 15. At this time, the sheet K transported at an adjusted timing is sandwiched between the intermediate transfer belt 15 and the secondary transfer roll 22. Then, if a voltage (secondary transfer bias) with the same polarity as the charging polarity (negative polarity) of the toner is applied from a power supply roll 26, a transfer field is formed between the secondary transfer roll 22 and the rear surface roll 25. Then, the unfixed toner images held on the intermediate transfer belt 15 are electrostatically transferred in a collective manner onto the sheet K at the secondary transfer unit 20 that is pressurized by the secondary transfer roll 22 and the rear surface roll 25.

Thereafter, the sheet K with the toner images electrostatically transferred thereon is directly transported in a state in which the sheet K is caused to peel off from the intermediate transfer belt 15 by the secondary transfer roll 22 and is then transported to the transport belt 55 provided on the downstream side of the secondary transfer roll 22 in the sheet transport direction. The transport belt 55 transports the sheet K up to the fixing unit 60 at an optimal transport speed for the fixing unit 60. The unfixed toner image on the sheet K transported to the fixing unit 60 is fixed on the sheet K by being subjected to a fixing treatment with heat and a pressure by the fixing unit 60. Then, the sheet K with the fixed image formed thereon is transported to a discharged sheet containing unit (not illustrated) provided at a discharging unit of the image forming apparatus.

Meanwhile, the toner remaining in the intermediate transfer belt 15 after the transferring onto the sheet K ends is transported up to the cleaning unit with the rotation of the intermediate transfer belt 15 and is removed from the intermediate transfer belt 15 by the cleaning rear surface roll 34 and the intermediate transfer belt cleaner 35.

Although the embodiment has been described above, the invention is not to be interpreted as being limited to the aforementioned embodiment, and various modifications, changes, and improvements may be made.

### EXAMPLES

Although examples of the invention will be described below, the invention is not limited to the following examples. Also, “parts” and “%” in the following description are all on a weight basis unless otherwise particularly indicated. The surface resistance in the surface layer and the volume resistance in the transfer belt are measured by the aforementioned methods.

### Example 1

—Preparation of Base Material Resin Solution—

27.5 parts by weight of carbon black particles (manufactured by Special Black 4 manufactured by Degussa) is added to a solution (1° % by weight of solid fraction after imide conversion) of N-methyl-2-pyrrolidene (NMP) of polyamic acid including 3,3′,4,4′-biphenyltetracarbon dianhydride and 4,4′-diaminodiphenylether with respect to a solid content of 100 parts by weight of polyamic acid, the mixture is mixed and stirred, thereby preparing a carbon black-dispersed polyimide precursor solution (base material resin solution).

—Preparation of Surface Layer Resin Solution—

Preparation of Imide Resin Solution (A)

As an imide resin, a polyamide-imide resin (a solution of N-methyl-2-pyrrolidone (NMP) solution (solid fraction of 13% by weight) of HPC-900) (manufactured by Hitachi Chemical Company Co., Ltd.)) is used. 45 parts by weight of carbon black particles (FW1: manufactured by Degussa) is added to and dispersed in the polyamide-imide solution with respect to 100 parts by weight of resin solid content, thereby preparing a carbon black-dispersed polyamide-imide solution.

Preparation of Siloxane-Modified Imide Resin Solution (B)

As a siloxane-modified imide resin, siloxane-modified polyetherimide (Siltem 1500 manufactured by SABiC Innovative Plastics) is used. Siloxane-modified polyetherimide is dissolved in NMP such that an amount of 20/by weight is achieved.

Preparation of Surface Layer Resin Solution

The imide resin solution (A) and the siloxane-modified imide resin solution (B) are mixed such that a weight ratio of the solid content of the resin derived from the imide resin solution (A) and the solid content of the resin derived from the siloxane-modified imide resin solution (B) is 20:1 and the amount of carbon is 14 parts by weight with respect to 100 parts by weight of sum of the solid content of the resin derived from the solution (A) and the solid content of the resin derived from the solution (B), thereby obtaining a surface layer resin solution.

—Production of Resin Base Material Layer—

A cylinder made of aluminum having an outer diameter of 278 mm and a length of 600 mm is prepared. The base material resin solution is ejected on the outer surface of the cylinder made of aluminum which rotates via a dispenser so as to provide a width of 500 mm. Thereafter, the resulting cylindrical tube is heated and dried at 140° C. for 30 minutes while being horizontally maintained and is then heated for 120 minutes such that the maximum temperature reaches 320° C., thereby forming a resin base material layer.

—Production of Surface Layer—

The surface layer resin solution is ejected on the outer surface of the obtained resin base material layer via a dispenser while the aluminum cylinder is caused to rotate together with the resin base material layer. Thereafter, the cylinder is heated and dried at 140° C. for 15 minutes while being horizontally maintained and is then heated for 120 minutes such that the maximum temperature reaches 260° C. Thereafter, a portion of the obtained product which the two layers have been applied on is subjected to cutting so as to obtain a cylinder having a length of 363 mm, thereby obtaining an intermediate transfer belt.

### Examples 2 and 3

Intermediate transfer belts are respectively produced in the same manner as in Example 1 except that the mixture ratios between the imide resin solution (A) and the siloxane-modified imide resin solution (B) are changed to weight ratios described in Table 1.

### Example 4

An intermediate transfer belt is produced in the same manner as in Example 1 except that a carbon blending ratio of the surface layer resin solution in Example 1 is change to 15 parts by weight.

### Example 5

An intermediate transfer belt is produced in the same manner as in Example 1 except that a carbon blending ratio of the surface layer resin solution in Example 1 is changed to 12 parts by weight.

### Examples 6 and 7

Intermediate transfer belts are respectively produced in the same manner as in Example 1 except that the mixture ratios between the imide resin solution (A) and the siloxane-modified imide resin solution (B) are changed to weight ratios described in Table 1.

### Example 8

An intermediate transfer belt is produced in the same manner as in Example 1 except that a carbon blending ratio in the surface layer resin solution in Example 1 is changed to 15.5 parts by weight.

### Example 9

An intermediate transfer belt is produced in the same manner as in Example 1 except that a carbon blending ratio in the surface layer resin solution in Example 1 is changed to 10 parts by weight.

### Example 10

An intermediate transfer belt is produced in the same manner as in Example 1 except that a carbon blending ratio of the surface layer resin solution in Example 1 is changed to 15.8 parts by weight.

### Example 11

An intermediate transfer belt is produced in the same manner as in Example 1 except that a carbon blending ratio of the surface layer resin solution in Example 1 is changed to 9.5 parts by weight.

### Comparative Example 1

An intermediate transfer belt is produced in the same manner as in Example 1 except that a surface layer in Example 1 is not applied.

### Comparative Example 2

The siloxane-modified imide resin solution in Example 1 is not used, and the resin solution A and the carbon black is are prepared such that a ratio therebetween is 15 parts by weight. An intermediate transfer belt is produced in the same manner as in Example 1 except that point.

### Comparative Example 3

As a siloxane-modified imide resin, siloxane-modified polyetherimide (Siltem 1500 manufactured by SABIC Innovative Plastics) is used. Siloxane-modified polyetherimide is dissolved in NMP such that an amount thereof is 20% by weight. 14 parts by weight of carbon black particles (FW1 manufactured by Degussa) based on 100 parts by weight of resin solid content is added and dispersed therein, thereby preparing a carbon black-dispersed siloxane-modified polyetherimide resin solution (C). An intermediate transfer belt is produced in the same manner as in Example 1 except that the carbon black-dispersed siloxane-modified polyetherimide resin solution (C) is used instead of the imide resin solution (A) and the siloxane-modified imide resin solution (B).

[Evaluation]

The transfer belt produced in each example is evaluated as follows.

—Evaluation Regarding Transferring Properties—

The obtained intermediate transfer belt is attached to an intermediate transfer belt incorporated in Iridesse Production Press (manufactured by Fuji Xerox Co., Ltd.), and transferring properties of the toner is evaluated by checking image deletion on a print sheet. Also, an embossed sheet (Lethack 66, 151 gsm, manufactured by Fuji Xerox Interfield Co., Ltd.) is used for the evaluation regarding transferring properties, and a solid image of a black halftone of 60% is evaluated.

A: No or substantially no image deletion is observed in recessed portions of the sheet.

B: Slight image deletion is observed in recessed portions of the sheet.

C: Image deletion is observed in substantially all recessed portions of the sheet.

Evaluation results are collectively shown in Table 1 below.

TABLE 1

| | Surface layer | | | | | | | | | Resin base material layer | | | | | Volume | |
|---|---|---|---|---|---|---|---|---|---|---|---|---|---|---|---|---|
| | Resin A | | Resin B | | | Conductive | | Surface | | | Conductive | | | | resistance | Evaluation |
| | | Content | | Content | | material | | resis- | Average | | material | | Average | | of transfer | regarding |
| | | WA | | WB | | | Content | tance | thick- | Type | | Content | thick- | | belt | trans- |
| | | (% by | | (% by | WB/ | | (% by | (log Ω/ | ness | of | | (% by | ness | TR/ | (log Ω · | ferring |
| | Type | weight | Type | weight) | WA | Type | weight) | sq.) | (μm) | resin | Type | weight) | (μm) | TS | cm) | properties |
| Exam- | PAI1 | 83.5 | PSI1 | 4.2 | 0.05 | CB | 12.3 | 12.0 | 5 | PI1 | CB | 21.6 | 75 | 15 | 11.0 | A |
| ple 1 | | | | | | | | | | | | | | | | |
| Exam- | PAI1 | 79.7 | PSI1 | 8.0 | 0.10 | CB | 12.3 | 12.0 | 5 | PI1 | CB | 21.6 | 75 | 15 | 11.0 | A |
| ple 2 | | | | | | | | | | | | | | | | |
| Exam- | PAI1 | 73.1 | PSI1 | 14.6 | 0.20 | CB | 12.3 | 12.0 | 5 | PI1 | CB | 216 | 75 | 15 | 11.0 | A |
| ple 3 | | | | | | | | | | | | | | | | |
| Exam- | PAI1 | 79.1 | PSI1 | 7.9 | 0.10 | CB | 13.0 | 11.0 | 5 | PI1 | CB | 21.6 | 75 | 15 | 10.0 | A |
| ple 4 | | | | | | | | | | | | | | | | |
| Exam- | PAI1 | 81.2 | PSI1 | 8.1 | 0.10 | CB | 10.7 | 13.5 | 5 | PI1 | CB | 21.6 | 75 | 15 | 12.5 | A |
| ple 5 | | | | | | | | | | | | | | | | |
| Exam- | PAI1 | 84.3 | PSI1 | 3.4 | 0.04 | CB | 12.3 | 12.2 | 5 | PI1 | CB | 21.6 | 75 | 15 | 11.1 | B |
| ple 6 | | | | | | | | | | | | | | | | |
| Exam- | PAI1 | 70.2 | PSI1 | 17.5 | 0.25 | CB | 12.3 | 12.0 | 5 | PI1 | CB | 21.6 | 75 | 15 | 11.0 | B |
| ple 7 | | | | | | | | | | | | | | | | |
| Exam- | PAI1 | 78.7 | PSI1 | 7.9 | 0.10 | CB | 13.4 | 10.5 | 5 | PI1 | CB | 21.6 | 75 | 15 | 9.6 | B |
| ple 8 | | | | | | | | | | | | | | | | |
| Exam- | PAI1 | 82.6 | PSI1 | 8.3 | 0.10 | CB | 9.1 | 14.0 | 5 | PI1 | CB | 21.6 | 75 | 15 | 12.7 | B |
| ple 9 | | | | | | | | | | | | | | | | |
| Exam- | PAI1 | 78.5 | PSI1 | 7.9 | 0.10 | CB | 13.6 | 10.8 | 5 | PI1 | CB | 21.6 | 75 | 15 | 9.8 | B |
| ple 10 | | | | | | | | | | | | | | | | |
| Exam- | PAI1 | 83.0 | PSI1 | 8.3 | 0.10 | CB | 8.7 | 14.3 | 5 | PI1 | CB | 21.6 | 75 | 15 | 13.0 | B |
| ple 11 | | | | | | | | | | | | | | | | |
| Compar- | — | — | — | — | — | — | — | — | — | PI1 | CB | 21.6 | 75 | — | 10.0 | C |
| ative | | | | | | | | | | | | | | | | |
| Exam- | | | | | | | | | | | | | | | | |
| ple 1 | | | | | | | | | | | | | | | | |
| Compar- | PAI1 | 87.0 | — | — | — | CB | 13.0 | 12.0 | 5 | PI1 | CB | 21.6 | 75 | 15 | 10.0 | C |
| ative | | | | | | | | | | | | | | | | |
| Exam- | | | | | | | | | | | | | | | | |
| ple 2 | | | | | | | | | | | | | | | | |
| Compar- | — | — | PSI1 | 88.7 | — | CB | 12.3 | 11.5 | 5 | PI1 | CB | 21.6 | 75 | 15 | 10.0 | C |
| ative | | | | | | | | | | | | | | | | |
| Exam- | | | | | | | | | | | | | | | | |
| ple 3 | | | | | | | | | | | | | | | | |

Details of abbreviations described in Table 1 will be described below.

PAI1: polyamide-imide resin (HPC-9000 manufactured by Hitachi Chemical Company Co., Ltd.)

PSI1: siloxane-modified polyetherimide (Siltem 1500 manufactured by SABC Innovative Plastics)

CB: carbon black particles (Special Black 4 manufactured by Degussa

PI1: polyimide resin prepared by the base material resin solution

It is possible to understand from the results shown in Table 1 above that the transfer belts in the examples have more excellent toner transferring properties with respect to an uneven sheet than the transfer belts in the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer belt comprising:
a resin base material layer; and
a surface layer,
wherein the surface layer contains a polyamide-imide resin A, a siloxane-modified imide resin B, and a conductive material.

2. The transfer belt according to claim 1, wherein the resin B is a siloxane-modified polyetherimide resin.

3. The transfer belt according to claim 1, wherein a ratio (WB/WA) between a content (WA) of the resin A and a content (WB) of the resin B in the surface layer is 0.03 or more and 0.30 or less.

4. The transfer belt according to claim 3, wherein the ratio (WB/WA) of the content (WA) of the resin A and the content (WB) of the resin B in the surface layer is 0.05 or more or 0.20 or less.

5. The transfer belt according to claim 1, wherein a surface resistance of the surface layer when a voltage of 100 V is applied for three seconds is 11.0 (log Ω/sq.) or more and 13.5 (log Ω/sq.) or less.

6. The transfer belt according to claim 1, wherein a volume resistance of the transfer belt when a voltage of 100 V is applied for five seconds is 10.0 (log Ω·cm) or more and 12.5 (log Ω·cm) or less.

7. The transfer belt according to claim 1, wherein the resin base material layer contains a polyimide resin.

8. The transfer belt according to claim 1, wherein the resin base material layer contains a conductive material.

9. The transfer belt according to claim 8, wherein a content of the conductive material in the resin base material layer is greater than a content of the conductive material in the surface layer.

10. The transfer belt according to claim 1, wherein a ratio (TR/TS) between an average thickness (TR) of the resin base material layer and an average thickness (TS) of the surface layer is 1 or more and 30 or less.

11. The transfer belt according to claim 1, wherein the transfer belt is an intermediate transfer belt.

12. A transfer unit comprising:
the transfer belt according to claim 1.

13. An image forming apparatus comprising:
an image holding member;
a charging unit that charges a surface of the image holding member;
an electrostatic latent image forming unit that forms an electrostatic latent image on a charged surface of the image holding member;
a developing unit that develops the electrostatic latent image formed on the surface of the image holding member with a developer containing a toner to form a toner image; and
the transfer unit according to claim 12 that transfers the toner image to a surface of a recording medium.
